(19) United States
(12) Patent Application Publication
(10) Pub. No.: US 2010/0245414 A1
(43) Pub. Date: Sep. 30, 2010

(54) Adjustment Assembly for Adjustably Mounting Guide Members on Printhead Carrier Support Frame to Establish Desired Print Gap

(76) Inventors: Sarah Marie Burroughs, Lexington, KY (US); Brain Dale Cook, Nicholasville, KY (US); Walter Kevin Cousins, Georgetown, KY (US); Serena Nicole Oaks, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/411,077

(22) Filed: Mar. 25, 2009

(51) Int. Cl. B41J 25/308

(52) U.S. Cl. 347/8

(57) ABSTRACT

An adjustment assembly adjustably mounts opposite ends of elongated guide members on opposite side panels of a printhead carrier support frame of a printer to establish a desired mounting relationship between the guide members and opposite side panels and thereby establish a desired print gap between a sheet of print media passing through a print zone and a printhead supported on a carrier reciprocally moving on the guide members. In addition to the opposite side panels, the adjustment assembly includes a pair of adjustment plates each for placement in a facing relationship with an outside surface of one of the opposite side panels and a plurality of mounting elements associated with the adjustment plates and opposite side panels that enable aligning and mounting them at the opposite ends of the guide members in the desired mounting relationship that establishes the desired print gap.

### CROSS REFERENCES TO RELATED APPLICATIONS

This patent application is related to the subject matter of a co-pending U.S. patent application Ser. No. (Docket No. 2007-0418.01) filed Jun. 30, 2008, assigned to the assignee of the present invention. The entire disclosure of this patent application is hereby incorporated herein by reference.

### BACKGROUND

1. Field of the Invention

The present invention relates generally to properly locating a printhead relative to a print media path in a printer and, more particularly, to an adjustment assembly for adjustably mounting guide members on a printhead carrier support frame to establish a desired gap between the printhead and print media during assembling of the printer.

2. Description of the Related Art

A conventional inkjet printer includes a frame which defines a print media path along which a sheet of print media is transported through a print zone in the printer. A printhead carrier supported by guide members, such as carrier shafts, on the frame undergoes reciprocating movement across the print media path for carrying and scanning at least one printhead through the print zone. As the printhead traverses the print zone it ejects drops of ink onto the sheet of print media at predefined locations to form a printed image thereon that is expected to be a high-quality replica of image data inputted to the printer for printing. The achievement of a high-quality printed image is dependent, at least in part, on establishing a desired gap between the printhead and the sheet of print media. If the guide members or carrier shafts supporting the printhead carrier are not properly positioned on the printer frame, the printhead will then not be properly spaced relative to the sheet of print media in the print zone and, as a consequence, the expected high quality of the image printed will be not be attained.

Thus, in inkjet printers it is desired to establish and maintain a constant, desired or known print gap between the printhead and the sheet of print media during printing for optimal print quality. Traditionally, this gap has been controlled by specifying small tooling and assembly tolerances. However, since there are many parts that control the gap, this method will yield some printers with an unacceptable gap. Printers with gaps that are too small, large, or uneven often have prints with visible defects, such as scraping marks or graininess. There have been previous efforts toward improving gap adjustments in printers where the printhead carrier is supported by a guide member or carrier shaft and a surface on the printer frame. However, these efforts have not allowed for a comprehensive front-to-back, or left-to-right, tilt adjustment which is desirable.

Thus, there is still a need for an innovation that will enable adjusting and establishing the desired print gap in the printer.

### SUMMARY OF THE INVENTION

The present invention meets this need by providing an innovation in the form of an adjustment assembly that can be used in adjusting and establishing the desired print gap in the printer during its assembling, such as by assemblers at a factory, to minimize print defects across all printers.

Accordingly, in an aspect of the present invention, an adjustment assembly for adjustably mounting elongated guide members on a printhead carrier support frame to establish a desired print gap includes a pair of side panels located on the carrier support frame, a pair of adjustment plates each for placement alongside one of the side panels, and a plurality of mounting elements associated with the opposite side panels and adjustment plates that enable aligning and mounting them at opposite ends of the elongated guide members in a desired mounting relationship that creates the desired print gap.

In another aspect of the present invention, in combination with a printhead carrier support frame of an inkjet printer having a pair of opposite side panels and a pair of elongated carrier guide members extending between the opposite side panels, an adjustment assembly for adjustably mounting the guide members on the opposite side panels to establish a desired print gap in the printer includes a pair of adjustment plates each for placement in a facing relationship with an outside surface of one of the opposite side panels, and a plurality of mounting elements associated with the opposite side panels and the adjustment plates that enable aligning and mounting them at opposite ends of the guide members in a desired mounting relationship that establishes the desired print gap.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a printhead carrier support frame incorporating an adjustment assembly for adjustably mounting guide members on a printhead carrier support frame to establish a desired print gap in accordance with the present invention.

FIG. 2 is a perspective fragmentary view on a reduced scale of an end of the carrier support frame with an adjustment plate subassembly of the adjustment assembly of FIG. 1 removed.

FIG. 3 is a perspective fragmentary view on a reduced scale of the adjustment plate subassembly of the adjustment assembly of FIG. 1.

FIG. 4 is an enlarged perspective fragmentary view of a corner portion of the carrier support frame of FIGS. 1 and 2 showing one of the four adjustment screws of the adjustment assembly of FIG. 1.

FIG. 5 is a top plan view of the adjustment screw as seen along line 5-5 of FIG. 4.

FIG. 6 is an enlarged perspective fragmentary view on an enlarged scale of an end of the carrier support frame with the adjustment assembly partially applied thereto.

FIG. 7 is an enlarged end elevational view of one of the carrier guide members on the carrier support frame disposed in aligned openings in the side panel of the frame and the adjustment plate subassembly.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

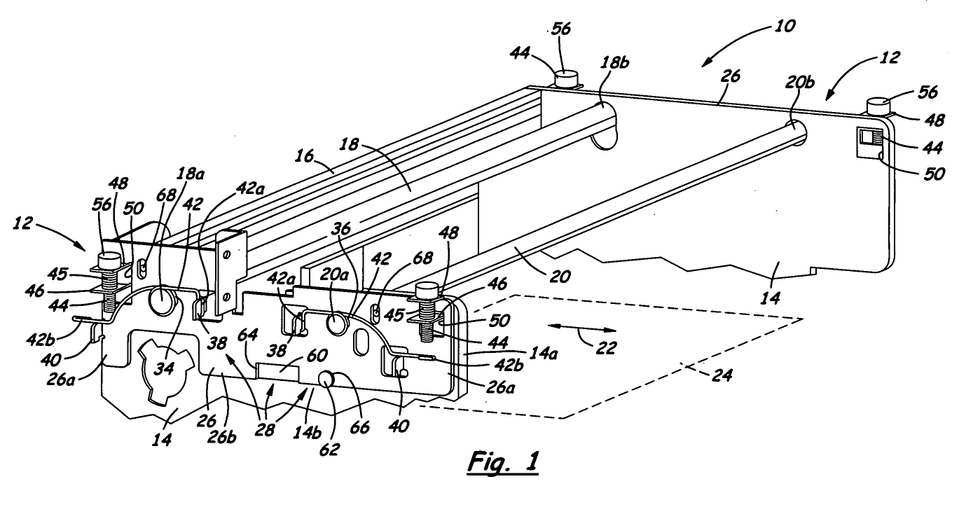

Referring now to FIG. 1, there is illustrated a frame portion of an inkjet printer in the form of a carrier support frame 10 to each opposite side of which is applied an adjustment assembly of the present invention, generally designated 12. The carrier support frame 10 is mounted stationary on the printer frame (not shown) and can be made of any suitable material, for example aluminum or steel. The carrier support frame 10 has opposite side panels 14 substantially identical to each other and interconnected by a reinforcing bracket 16. Also, the carrier support frame 10 has fore-and-aft spaced carrier guide members 18, 20, in the form of shafts, rails or rods and made of any suitable material, for example aluminum or steel. The guide members 18, 20 extend between the side panels 14 and at their opposite ends 18a, 18b and 20a, 20b are retained at side panels 14. A print media path 22 passes under the carrier support frame 10 and through a print zone 24 also located thereunder.

As can be understood from the above cross-referenced application, a printhead carrier typically is supported on the carrier support frame 10 by the guide members 18, 20 to undergo reciprocating movement between the opposite side panels 14. As the printhead carrier undergoes reciprocating movement it carries and scans at least one printhead across the print media path 22 and through the print zone 24. As the printhead traverses the print zone 24 it ejects drops of ink onto a sheet of print media at predefined locations to form a printed image thereon. Achievement of a printed image of high quality is dependent, at least in part, on proper mounting and alignment of the guide members 18, 20 on the opposite side panels 14 of the carrier support frame 10 to establish and maintain a desired print gap between the printhead and the sheet of print media.

Referring now to FIGS. 1-3, in accordance with the present invention the adjustment assembly 12 is provided for adjustably mounting the opposite ends 18a, 18b and 20a, 20b of the guide members 18, 20 on the opposite side panels 14 of the printhead carrier support frame 10 so that the desired print gap is established between the sheet of print media passing through the print zone 24 and the printhead supported on the carrier reciprocally moving on the guide members 18, 20. In conjunction with the aforementioned opposite side panels 14, the adjustment assembly 12 includes a pair of adjustment plates 26 each for placement in a facing relationship with an outside surface 14a of one of the opposite side panels 14 and identical pluralities of mounting elements, generally indicated 28, associated with the respective opposite side panels 14 and respective adjustment plates 26. One plurality of mounting elements 28 facilitates or enables aligning, connecting and mounting a given one of the adjustment plates 26, a given one of the side panels 14, and corresponding given ones of the opposite ends 18a, 18b and 20a, 20b of the guide members 18, 20 in a desired mounting relationship, as seen in FIG. 1, that establishes the desired print gap. The concept underlying the present invention is to have substantially identical components making up the adjustment assembly 12 on each of the opposite side panels 14 of the carrier frame 10 in the desired mounting relationship.

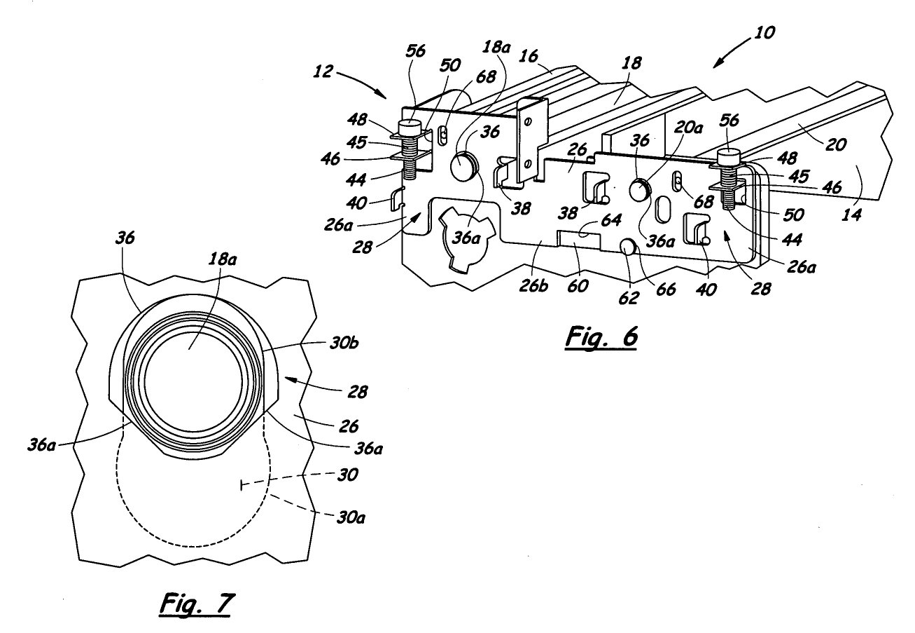

In view that only the outside of the left side panel 14 can be seen in FIGS. 1, 2 and 6, also that the right side panel 14 is substantially identical to the left side panels 14, and further that identical pluralities of mounting elements 28 are associated with the side panels 14, only one plurality of mounting elements 28 that is associated with one adjustment plate 26 and the left side panel 14 will be described hereinafter. The mounting elements 28 include first and second slots 30, 32 in the side panel 14 which correspond to and align with first and second openings 34, 36 in the adjustment plate 26. When the side panel 14 and adjustment plate 26 are aligned, their corresponding first and second slots 30, 32 and openings 34, 36 overlap each other such that the ends 18a, 20a of the guide members 18, 20 extend through the overlapped slots and openings 30, 34 and 32, 36, providing the adjustment plate 26 in the facing relationship with the side panel 14.

The first slot 30 in the side panel 14 has a key-hole configuration formed by a lower portion 30a that is wider than an upper portion 30b and thus adapted to allow for easier installation of the end 18a of the one guide member 18 without damaging the surface finish of the guide member 18. The wider lower portion 30a merges into the narrower upper portion 30b whose width is only slightly greater than the diameter of the guide member end 18a which limits the front-to-back (or sidewise) motion of the guide member 18. The second slot 32 in the side panel 14 has an enlarged configuration adapted to allow easy installation of the end 20a of the other guide member 20. The first and second openings 34, 36 of the adjustment plate 26 have bearing edge portions 34a, 36a that are shallow V-shaped so that they stationarily support the ends 18a, 20a of the guide members 18, 20 at their lower sides so as to prevent the substantially cylindrical-shaped guide members 18, 20 from rolling sidewise on the bearing edge portions 34a, 36a.

Also, the mounting elements 28 include first and second pairs of tabs 38, 40 protruding substantially perpendicularly from an outer side 26a of the adjustment plate 26, and a pair of resilient yieldable retainer spring clips 42 which are anchored and seated by the tabs 38, 40 along the outer side 26a of the adjustment plate 26. The spring clips 42 also encircle and grip the one ends 18a, 20a of the guide members 18, 20 so as to retain the ends 18a, 20a extending through the aligned first and second slots and openings 30, 34 and 32, 36 of the side panel 14 and adjustment plate 26. Thus, the one ends 18a, 20a of the guide members 18, 20 located in the openings 34, 36 of the adjustment plate 26 are supported on the V-shaped bearing edge portions 34a, 36a. Also, the one ends 18a, 20a of the guide members 18, 20 are retained on the V-shaped bearing edge portions 34a, 36a by attaching the retainer spring clips 42 to the adjustment plate 26. One end 42a of each spring clip 42 is hook or U-shaped to fit with one tab 38 which is also hook or U-shaped. The opposite end 42b of each spring clip 42 rests or seats on the top of the other tab 40.

Further, the mounting elements 28 include a pair of screws 44, a pair of springs 45 and two pair of mounting tabs 46, 48 associated with each adjustment plate 26 and its corresponding side panel 14 which make the adjustment plate 26, and thus the guide members 18, 20, adjustable in their positions relative to the corresponding side panel 14 of the carrier frame 10. The adjustment plate 26 is adjustable relative to the corresponding side panel 14 at two points proximate the respective opposite ends 14a, 26a of the side panel 14 and adjustment plate 26. Thus, there are a total of four points of adjustment such that the average print gap, in terms of front-to-back variation in the print gap and side-to-side variation in the print gap, can all be adjusted by an assembler at the factory manipulating the screws 44. Each adjustment point is thus controlled by a screw 44 and a spring 45 which fits over the screw 44.

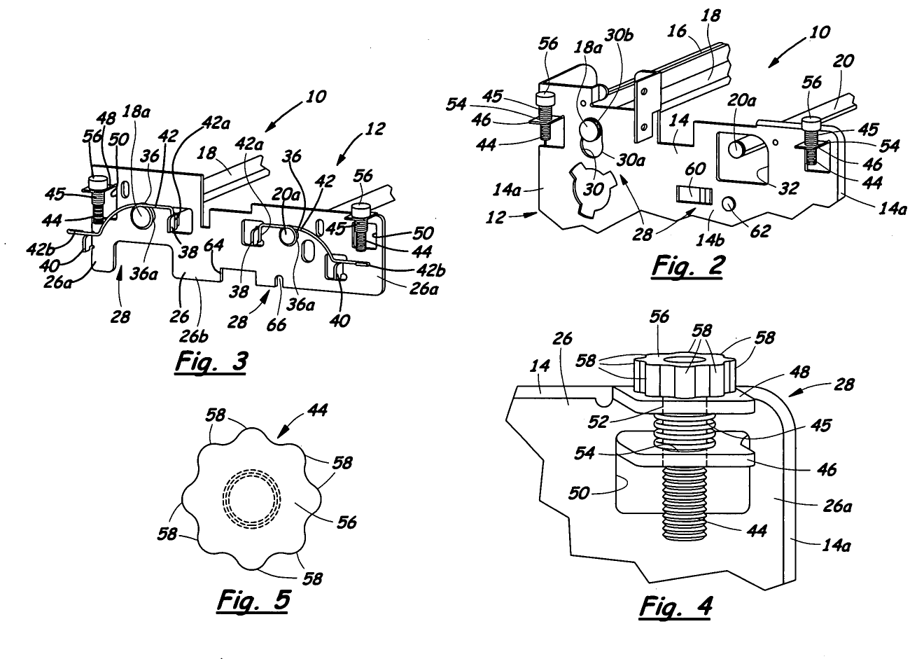

In FIGS. 2-4, it will be observed that the mounting tabs 46, 48 are attached on the side panel 14 and adjustment plate 26. They can align in a vertically spaced relationship with the upper mounting tabs 48 on the adjustment plate 26 disposed above the lower mounting tabs 46 on the side panel 14 when the adjustment plate 26 is positioned alongside the side panel 14. The lower mounting tabs 46 on the side panel 14 extend through openings 50 in the adjustment plate 26 located below its upper mounting tabs 48. Each screw 44 is inserted through a clearance hole 52 in an upper mounting tab 48 of the alignment plate 26 and threaded through a threaded hole 54 in a lower mounting tab 46 of the side panel such that the lower mounting tab 46 is the one that supports or holds the screw 44. Each spring 45 is installed about a screw 44 between the lower and upper mounting tabs 46, 48. As each screw 44 is turned clockwise or counterclockwise, it threads into or from the lower mounting tab 46 and thus moves downward or upward relative to the side panel 26, correspondingly compressing the spring 45 to move the mounting tabs 46, 48 closer toward one another or relaxing the spring 45 which moves the mounting tabs 46, 48 farther away from each other. Furthermore, as each screw 44 moves downward or upward, the spring 45 holds the upper mounting tab 48 of the adjustment plate 26 against the underside of a head 56 of the screw 44. Adjustment of the screw 44 is achieved, either upward or downward, by gripping and turning its head 56. In FIGS. 4 and 5, it can be seen that the head 56 of the screw 44 has eight partitions 58 on it that allow discrete turning adjustments to be made by assemblers on the factory assembly line for achieving accuracy in mounting the guide members 18, 20 to the carrier frame 10.

Thus, it will be observed that at a given side of the carrier frame 10 the given one ends 18a, 20a of the guide members 18, 20 extend through the slots 30, 32 and are held in place by the adjustment plate 26. When any one screw 44 is adjusted, the adjustment plate 26 will tend to rotate some in addition to moving up or down. This rotation could result in front-to-back movement of the guide members 18, 20. However, the narrower upper portion 30b of the U-shaped first slot 30 in each of the side panels 14 of the carrier frame 10 minimizes any front-to-back motion of the guide members 18, 20.

Finally, the mounting elements 28 include protuberances in the form of a rectangular-shaped block 60 and a circular-shaped pin 62 protruding from each side panel 14 at locations 14b intermediate between opposite ends 14a of the side panel 14. The mounting elements 28 also include a rectangular-shaped cutout 64 and a circular-shaped cutout 66 defined at locations along a lower edge 26b and intermediate between the opposite ends 26a of the adjustment plate 26. The cutouts 64, 66 insert over the block 60 and pin 62 when the adjustment plate 26 is properly placed alongside the side panel 14. The pins 62 help to keep the adjustment plates 26 flush with the outsides of the opposite side panels 14 of the frame 10. Therefore, during the initial installation of the adjustment plate 26 the cutouts 64, 66 are slid over the matching or corresponding block 60 and pin 62, establishing a nominal print gap at which a first measurement is taken. The adjustment screws 44 are then rotated either clockwise or counterclockwise to match this height initially. After the first measurement, the necessary adjustment will be calculated for each screw 44 and communicated to the assembly line worker to make the additional adjustment. The adjustment screws 44 are all at the same height and are located at mirrored points on either side of the carrier frame 10, enabling a more even adjustment.

After the print gap adjustment is complete, there are two locking screws 68 extending through holes in the side panel 14 near the locations of the ends 18a, 20a of the guide members 18, 20. These locking screws 68, when tightened, fix the positions of the guide members 18, 20 and so help to prevent further movement of the adjustment plates 26 and guide members 18, 20 during packing, shipping, etc.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. An adjustment assembly for adjustably mounting elongated guide members on a printhead carrier support frame to establish a desired print gap, comprising:
a pair of side panels located on a carrier support frame;
a pair of adjustment plates each for placement alongside one of said side panels; and
a plurality of mounting elements associated with said opposite side panels and said adjustment plates that enable aligning and mounting them at opposite ends of elongated guide members in a desired mounting relationship that creates the desired print gap.

2. The assembly of claim 1 wherein said plurality of mounting elements include first and second slots in each of said side panels which corresponds to and aligns with first and second openings in each of said adjustment plates such that when said adjustment plates are placed in said mounting relationship with said side panels said slots and openings overlap and said opposite ends of said elongated guide members extending through said overlapped slots and openings.

3. The assembly of claim 2 wherein said slots have lower portions that are wider than upper portions thereof allowing movement of said opposite ends of said guide members into said upper portions thereof after installation into said lower portions of said slots.

4. The assembly of claim 2 wherein said openings of said adjustment plates have V-shaped bearing edge portions for supporting said opposite ends of said guide members.

5. The assembly of claim 2 wherein said plurality of mounting elements further includes first and second tabs protruding from a side of said adjustment plate and a pair of resilient yieldable retainer springs gripping said opposite ends of said guide members and attached to at least said first tabs.

6. The assembly of claim 5 wherein said plurality of mounting elements further include pluralities of screws, springs and mounting tabs associated with each adjustment plate and corresponding side panel which facilitate adjusting positions of said adjustment plates and said guide members at four points relative to said side panels of said frame.

7. The assembly of claim 6 wherein one of said screws inserts through a clearance hole in an upper one of said tabs on said alignment plate and threads through a threaded hole in a lower one of said tabs on said side panel and is encircled by a spring between said upper and lower tabs such that turning of said screw in one or the other opposite direction causes movement of said adjustment plate upward or downward relative to said side plate of said frame.

8. The assembly of claim 2 wherein said plurality of mounting elements further include pluralities of screws, springs and mounting tabs associated with each adjustment plate and corresponding side panel which facilitate adjusting positions of said adjustment plates and said guide members at four points relative to said side panels of said frame.

9. The assembly of claim 8 wherein said one of said screws inserts through a clearance hole in an upper one of said tabs on said alignment plate and threads through a threaded hole in a lower one of said tabs on said side panel and is encircled by a spring between said upper and lower tabs such that turning of said screw in one or the other opposite direction causes movement of said adjustment plate upward or downward relative to said side plate of said frame.

10. The assembly of claim 1 wherein said adjustment plates has cutouts that match and seat on protuberances on said side panels so as to initially align and locate said adjustment plates alongside said side panels, and locking screws for securing said adjustment plates to said side panels.

11. In combination with a printhead carrier support frame of an inkjet printer having a pair of opposite side panels and a pair of elongated carrier guide members extending between said opposite side panels, an adjustment assembly for adjustably mounting said guide members on said opposite side panels to establish a desired print gap in said printer, said adjustment assembly comprising:
a pair of adjustment plates each for placement in a facing relationship with an outside surface of one of said opposite side panels; and
a plurality of mounting elements associated with said opposite side panels and said adjustment plates that enable aligning and mounting them at opposite ends of said guide members in a desired mounting relationship that establishes the desired print gap.

12. The assembly of claim 11 wherein said plurality of mounting elements include first and second slots in each of said side panels which corresponds to and aligns with first and second openings in each of said adjustment plates such that when said adjustment plates are placed in said mounting relationship with said side panels said slots and openings overlap and said opposite ends of said elongated guide members extending through said overlapped slots and openings.

13. The assembly of claim 12 wherein said slots have lower portions that are wider than upper portions thereof allowing movement of said opposite ends of said guide members into said upper portions thereof after installation into said lower portions of said slots.

14. The assembly of claim 12 wherein said openings of said adjustment plates have V-shaped bearing edge portions for supporting said opposite ends of said guide members.

15. The assembly of claim 12 wherein said plurality of mounting elements further includes first and second tabs protruding from a side of said adjustment plate and a pair of resilient yieldable retainer springs gripping said opposite ends of said guide members and attached to at least said first tabs.

16. The assembly of claim 15 wherein said plurality of mounting elements further include pluralities of screws, springs and mounting tabs associated with each adjustment plate and corresponding side panel which facilitate adjusting positions of said adjustment plates and said guide members at four points relative to said side panels of said frame.

17. The assembly of claim 16 wherein one of said screws inserts through a clearance hole in an upper one of said tabs on said alignment plate and threads through a threaded hole in a lower one of said tabs on said side panel and is encircled by a spring between said upper and lower tabs such that turning of said screw in one or the other opposite direction causes movement of said adjustment plate upward or downward relative to said side plate of said frame.

18. The assembly of claim 12 wherein said plurality of mounting elements further include pluralities of screws, springs and mounting tabs associated with each adjustment plate and corresponding side panel which facilitate adjusting positions of said adjustment plates and said guide members at four points relative to said side panels of said frame.

19. The assembly of claim 18 wherein said one of said screws inserts through a clearance hole in an upper one of said tabs on said alignment plate and threads through a threaded hole in a lower one of said tabs on said side panel and is encircled by a spring between said upper and lower tabs such that turning of said screw in one or the other opposite direction causes movement of said adjustment plate upward or downward relative to said side plate of said frame.

20. The assembly of claim 11 wherein said adjustment plates has cutouts that match and seat on protuberances on said side panels so as to initially align and locate said adjustment plates alongside said side panels, and locking screws for securing said adjustment plates to said side panels.
